(19) United States
(12) Patent Application Publication
(10) Pub. No.: US 2018/0315052 A1
(43) Pub. Date: Nov. 1, 2018

(54) SYSTEM AND METHOD FOR MEASURING USER BEHAVIOR IN ELECTRONIC TRANSACTION BASED ON AN IMMUNITY SYSTEM

(71) Applicant: TONGJI University, Shanghai (CN)

(72) Inventors: Changjun JIANG, Shanghai (CN); Chungang YAN, Shanghai (CN); Hongzhong CHEN, Shanghai (CN); Zhijun DING, Shanghai (CN); Shaoping JIANG, Shanghai (CN)

(21) Appl. No.: 16/028,314

(22) Filed: Jul. 5, 2018

Related U.S. Application Data
(63) Continuation-in-part of application No. 15/504,826, filed on Feb. 17, 2017, now abandoned.

(30) Foreign Application Priority Data
Sep. 14, 2015 (CN) PCT/CN2015/089511

(51) Int. Cl. G06Q 20/40; H04L 29/08

(52) U.S. Cl. CPC G06Q 20/4016; G06F 17/30528; H04L 67/22; G06Q 20/4014

(57) ABSTRACT

System and methods for performing behavior evaluation based on an immunity system is provided. A method may include receiving historical behavior data containing user activities performed in an electronic transaction. The method may include extracting normal transaction sequences and abnormal transaction sequences from the historical behavior data. The method may include storing the normal transaction sequences into a normal transaction library and the abnormal transaction sequences into an abnormal transaction library. The method may further include, in response to receiving a current behavior data, extracting a current transaction sequence from the current behavior data, and in response to a successful matching comparison of the current transaction sequence with an abnormal transaction sequence in the abnormal transaction library, transmitting a first abnormal evaluation result as a response to the receiving of the current behavior data.

### CROSS-REFERENCE

This is a continuation-in-part application based on a pending U.S. patent application Ser. No. 15/504,826, filed on Feb. 17, 2017, which claims priority to a PCT Application No. PCT/CN2015/089511, filed on Sep. 14, 2015, both of which are hereby incorporated by reference in their entireties, including any appendices or attachments thereof, for all purposes.

### TECHNICAL FIELD

The present disclosure relates to system and method to measure user behavior for securing Internet transactions and online payments.

### BACKGROUND

In recent years, e-commerce and online payment transactions have become increasingly popular. However, potential hazards due to malicious behaviors such as frauds and hacking are threatening the credibility of these electronic transactions. These malicious behaviors are not consistent with normal user behaviors and habits, and detecting such behavior inconsistencies in order to prevent abnormal infringements in electronic transactions is greatly needed.

In real-life situations, many traditional authentication systems (e.g., using name and password) can no longer guarantee the security of the electronic transactions, and many conventional threat prevention approaches cannot evolve fast enough to identify new fraudulent activities. Therefore, many e-commerce and third-party payment platforms have to utilize a non-automated detection method by manually adding the rules that can detect abnormal behaviors. As a result, the fraud detection rate is low, and costs to manpower and resources are high.

### SUMMARY

System and methods for performing behavior evaluation based on an immunity system is provided. A method may include receiving historical behavior data containing user activities performed in an electronic transaction. The method may include extracting normal transaction sequences and abnormal transaction sequences from the historical behavior data. The method may include storing the normal transaction sequences into a normal transaction library and the abnormal transaction sequences into an abnormal transaction library. The method may further include, in response to receiving a current behavior data, extracting a current transaction sequence from the current behavior data, and in response to a successful matching comparison of the current transaction sequence with an abnormal transaction sequence in the abnormal transaction library, transmitting a first abnormal evaluation result as a response to the receiving of the current behavior data.

### BRIEF DESCRIPTION OF THE DRAWINGS

To clarify the present disclosure, the accompanying drawings for the various embodiments are briefly described below.

FIG. 1 illustrates a block diagram of a behavior evaluation environment that provides user behavior evaluations based on an immunity system;

FIG. 2 illustrates a process performed by a behavior evaluation system for evaluating user behavior;

FIG. 3-A illustrates exemplary transaction sequences;

FIG. 3-B illustrates evolving transaction sequences that are associated with a single user performing a specific electronic transaction;

FIG. 4-A illustrates a process to perform a mutation process;

FIG. 4-B illustrates a process to perform a mutation operation;

FIG. 5 illustrated a chart showing the improvement of the immunity method provided by the immunity system; all arranged in accordance with certain embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

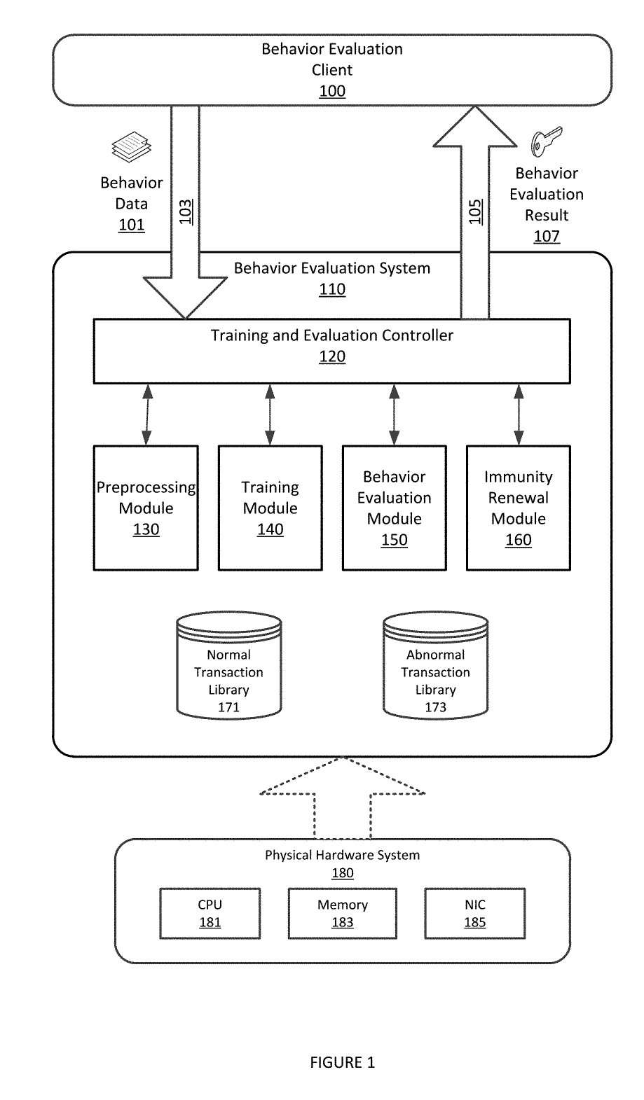

FIG. 1 illustrates a block diagram of a behavior evaluation environment that provides user behavior evaluations based on an immunity system, according to one or more embodiments of the present disclosure. In FIG. 1, a behavior evaluation client 100 may interact with a behavior evaluation system 110 to perform user behavior evaluation during electronic transactions. In some embodiments, the behavior evaluation client 100 may be a web-based software module or hardware module interacting with the behavior evaluation system 110 via Internet network communication protocols such as Hypertext Transfer Protocol (HTTP). The behavior evaluation client 100 may also be a software application installed on a remote networked computer and interacting with the behavior evaluation system 110 via Transmission Control Protocol/Internet Protocol (TCP/IP) communications.

In some embodiments, the behavior evaluation client 100 may be accessed by one or more users participating in electronic transactions such as online shopping or secure banking transactions. The behavior evaluation client 100 may monitor these users' behaviors during such electronic transactions. Examples of monitored user behaviors may include electronic/online user actions/activities such as data inputting (e.g., inputting user names and passwords), web-page accessing (e.g., accessing specific secured web sites), web-browsing patterns, payment transactions, data updating actions (e.g., updating personal credentials), etc. The behavior evaluation client 100 may collect these monitored user behaviors as user behavior data 101, embedded such user behavior data 101 in a request message, and transmit (103) the request message to the behavior evaluation system 110 for user behavior evaluation and suspicious activity detection.

In some embodiments, the behavior evaluation system 110, which may be constructed based on a physical hardware system 180, may include, without limitation, a training and evaluation controller 120, a preprocessing module 130, a training module 140, a behavior evaluation module 150, an immunity renewal module 160, a normal transaction library 171, and an abnormal transaction library 173. The training and evaluation controller 120 may be configured to receive (103) behavior data 101 from the behavior evaluation client 100, and invoke multiple internal modules (e.g., modules 130, 140, 150, and/or 160) to perform behavior evaluation based on an immunity system. Afterward, the training and evaluation controller 120 may generate a behavior evaluation result 107, embed the behavior evaluation result 107 in a response message, and transmit (105) the response message back to the behavior evaluation client 100 in response to the previously received request message.

In some embodiments, the “behavior evaluation result” 107 may be a value (e.g., a specific value, a degree value within a specific range, or a percentage value) that can be used to quantify the trustworthy-ness of the behavior data 101. In other words, the behavior evaluation result 107 may be used to describe whether the received behavior data 101 is normal or abnormal. A lower behavior evaluation result may indicate that the behavior data 101 is more-likely abnormal/suspicious, is less trustworthy, and may indicate possibly fraudulent and suspicious situations. A higher behavior evaluation result may show that the behavior data 101 is more likely generated by authenticated user in a normal situation, and can be relied upon.

In some embodiments, the behavior evaluation system 110 may utilize an immunity system to evaluate the validity of the behavior data 101. Specifically, the “immunity system” may include an immunity method that is implemented by the various modules 130, 140, 150, and 160, as well as include one or more libraries 171 and 173. Through the immunity method and the immunity system, the behavior evaluation system 110 may utilize historical behavior data 101 to establish a normal transaction library 171 which can reflect recent behavior habits of a specific user in electronic transactions, and establish an abnormal transaction library 173 through an immunity reverse selection algorithm. The behavior evaluation system 110 may then evaluate new behavior data 101 against the normal transaction library 171 and the abnormal transaction library 173, in order to determine whether the user actions represented by the new behavior data 101 are normal or abnormal. Further, the behavior evaluation system 110 may evolve the normal transaction library 171 and the abnormal transaction library 173 by identifying and discarding aged data contained therein, and adding the new transaction-related data to the libraries.

In some embodiments, the preprocessing module 130 may be configured to preprocess behavior data received from the behavior evaluation client 100. The preprocessing module 130 may process the behavior data 100 into transaction data having a sequential format, and clean the transaction data.

In some embodiments, the training module 140 may process the normal historical transaction data that are generated from a specific trusted user, and generate a normal transaction library 171 that reflects the normal behaviors and habits of the specific user. Likewise, the training module 140 may process known abnormal historical transaction data, and generate an abnormal transaction library 173.

In some embodiments, when new behavior data 101 is received from the behavior evaluation client 100, the behavior evaluation module 150 may extract a new transaction data from the new behavior data 101, and analyze the new transaction data based on the normal transaction library 171 and the abnormal transaction library 173. Based on the analysis outcome, the behavior evaluation module 150 may generate a “normal” or “abnormal” behavior evaluation result 107 for the behavior evaluation client 100.

In some embodiments, the immunity renewal module 160 may calculate an age value of each transaction data in the libraries 171 and 173, according to a time order and an age evolution process. The immunity renewal module 160 may delete/remove aged transaction data in the libraries according to the age values, and/or removing the aged transaction data from any matching or mutation operations. The immunity renewal module 160 may perform the similar evolution process to renew the transaction data in the abnormal transaction library 173 (i.e., a non-selves library). By maintaining the transaction data in the libraries 171 and 173 up-to-date, the immunity renewal module 160 may achieve a fast immune effect toward newly identified abnormal activities.

In some embodiments, the behavior evaluation module 150 may detect whether a new behavior data 101 is mutated or not. Specifically, if the result of evaluating the new behavior data 101 is normal, the behavior evaluation module 150 may add the new transaction data into, the normal transaction library 171, perform an age-updating to the normal transaction library 171 according to the age evolution process, and delete “aged” transaction data in the library 171 in order to guarantee that the antibody set can reflect recent behavior habits of the user. If the result of evaluating the new behavior data 101 is abnormal, the behavior evaluation module 150 may add the new transaction data into, the abnormal transaction library 173, perform an age-updating to the abnormal transaction library 173 according to the age evolution process, and clean the aged transaction data contained in the library 173. Thus, the deleting and cleaning of the aged transaction data is similar to a self-stabilized biological immunity mechanism that cleans aged cells in order to keep the biological organic alive.

In some embodiments, the normal transaction database 171 and the abnormal transaction database 173 may be data storage modules configured for storing behavior data, transaction data, and immunity-related data (e.g., transaction sequences). In some embodiments, the databases 171 and 173 may be implemented in storage medium (e.g., memory or hard drive) located within the behavior evaluation system 110. Alternatively, the databases 171 and 173 may also be remote data storage services (e.g., data cloud) that can provide data services via network communications.

It should be recognized that the various terms, layers and categorizations used to describe the components in FIG. 1 may be referred to differently without departing from their functionalities or the spirit and scope of the present disclosure. For example, the training and evaluation controller 120 and the modules 130, 140, 150, and 160 may be located in the same physical hardware system 180, while the normal transaction database 171 and/or the abnormal transaction database 173 may be deployed on another physical hardware system 180.

In some embodiments, the physical hardware system 180 may be configured with, without limitation, a Central Processing Unit (CPU) 181, memory 183, a Network Interface Card (NIC) 185, and/or additional electronic circuit components not shown in FIG. 1. The CPU 181 may be a general-purpose or specialized computing processor having electronic circuitry to perform arithmetical, logical, and input/output operations for the physical hardware system 180. The CPU 181 may be configured to supply functionalities of the training and evaluation controller 120 as well as modules 130, 140, 150, and 160. The CPU 181 may also be configured to utilize the physical memory 183 to store or retrieve immunity-related data. The memory 183 may be hardware storage devices having integrated circuits for storing information used in the behavior evaluation system 110. The memory 183 may be volatile memory (e.g., dynamic random-access memory (DRAM) or CPU cache memory) and non-volatile memory (e.g., hard drive or flash memory). In some embodiments, the memory 183 may be non-transitory computer-readable storage medium, containing a set of instructions which, when executed by the CPU 181, cause the CPU 181 to perform a method of behavior evaluation. The NIC 185 may be network communication hardware for transmitting messages among the various components (e.g., the training and evaluation controller 120 and the modules 130, 140, 150, and 160) within, or delivering messages in and out of, the behavior evaluation system 110. In some embodiments, the behavior evaluation system 110 may be implemented in a distributed virtualized environment (e.g., using virtualization applications such as VMWARE® vCenter).

In some embodiments, the An immune method for a user behavior mode detection in an electronic transaction process is a process of extracting a normal sequence library which can best reflect recent behavior habits of a user according to historical transaction operation sequences of the user and according to an age evolution process; and when a new transaction sequence is generated, detecting whether the newly generated sequence is abnormal or not according to an abnormal sequence library and the normal sequence library; and updating the corresponding library in time according to a detection result.

Thus, the present disclosure provides an immune method for detecting abnormal user behaviors in an electronic transaction, and has the features of controllability, preventability, self-adaptability, self-learning, etc. Further, the normal transactions and abnormal transactions in electronic transaction may be comprehensively considered as originating from “selves” or “non-selves”; and the age of the historical transaction data may be adjusted through an evolution process for better adaptation to user behaviors and habits changes throughout time. The evolution process also guarantees that similar abnormal transaction can be found in time, thereby resulting an immune effect.

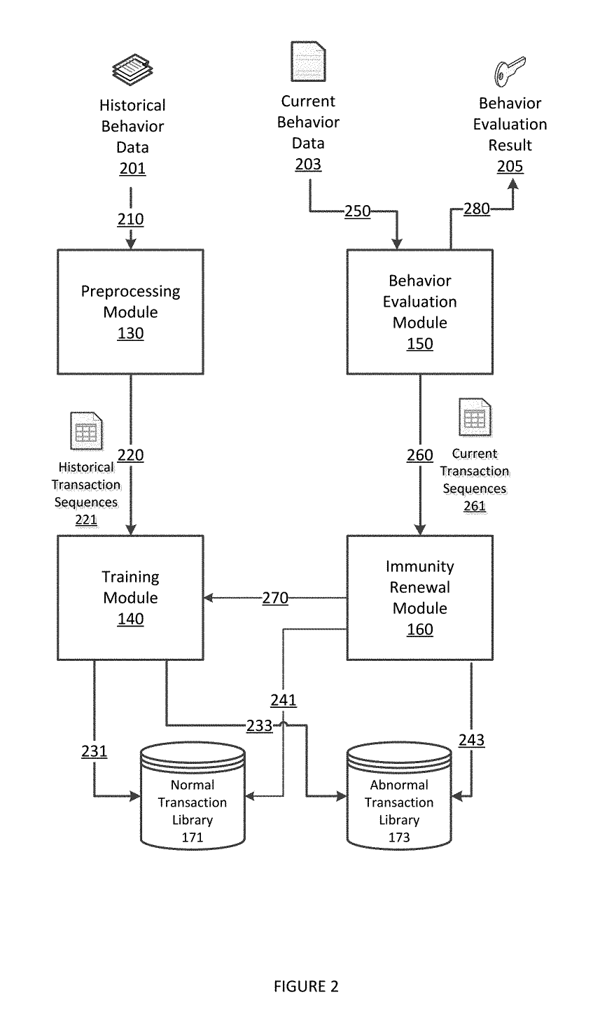

FIG. 2 illustrates a process performed by a behavior evaluation system for evaluating user behavior, according to certain embodiments of the present disclosure. Specifically, the behavior evaluation system in FIG. 2, including modules 130, 140, 150 and 160, as well as libraries 171 and 173 contained therein, correspond to the behavior evaluation system 110 and the respective modules and libraries that are marked by the same numbers in FIG. 1.

In some embodiments, the behavior evaluation system may first perform a training operation based on historical behavior data 201. A training and evaluation controller (similar to the training and evaluation controller 120 of FIG. 1, not shown in FIG. 2) of the behavior evaluation system may receive the historical behavior data 201 from a dependable behavior evaluation client that can collect secure and reliable behavior data from trustworthy users. Afterward, the training and evaluation controller may pass (210) the historical behavior data 201 to the preprocessing module 130 and the training module 140 for the training operation.

In some embodiments, the preprocessing module 130 may extract a set of transaction sequences 221 from the historical behavior data 201, and transmit (220) the extracted transaction sequences 221 to the training module 140 for training purposes. Specifically, the “transaction sequences” may include a set of user operations/actions performed by a specific user during an electronic transaction. For example, a set of transaction sequences 221 may include a sequential list of user operations/actions (some of which may be repeated) performed on a specific application during a fixed period of time.

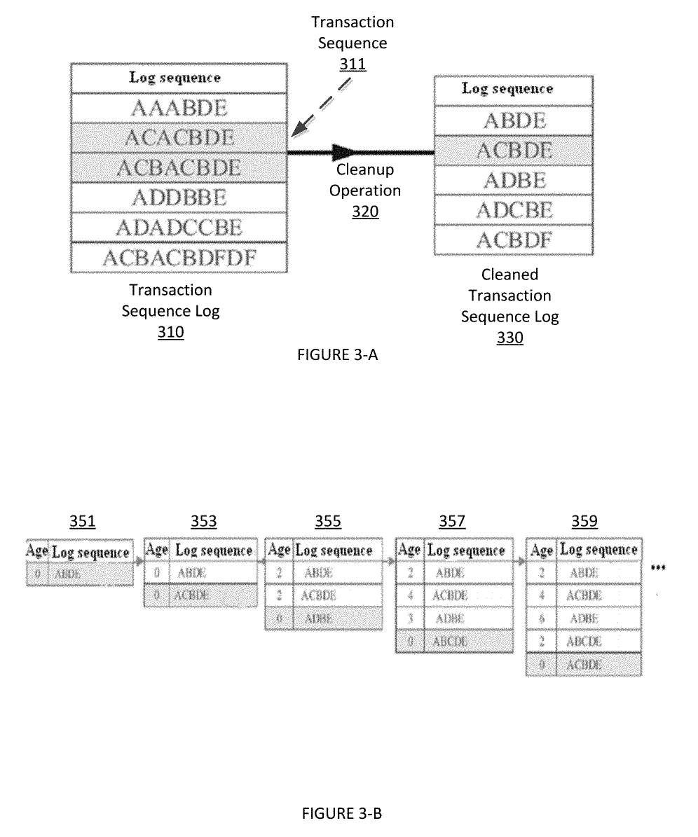

FIG. 3-A illustrates exemplary transaction sequences, according to certain embodiments of the present disclosure. In FIG. 3-A, transaction sequence log 310 may include multiple transaction sequences 311. Assuming the preprocessing module 130 uses the following symbols to represent certain user actions during an online shopping event: A=search; B=order; C=shopping cart; D=examine; E=payment; F=cancel; and G=return. In this case, A may represent that the online shopping event started from a web search of the goods; B and C may represent direct-ordering or ordering after placing goods into a shopping cart; D may represent examining the total cost balance of the goods occurring after the B (or C) actions; E and F may represent two possible outcomes after the D action, meaning the user either make the purchase or cancel the order; and G may represent that the user exits this online shopping event. Please note that G may be a subsequent action following any one of the other A, B, C, D, E, and F actions.

In some embodiments, after extracting the transaction sequences 311 from the behavior data, the preprocessing module 130 may perform a cleanup operation 320 on the transaction sequences 311, in order to combine duplicated user actions, and/or remove meaningless user actions. The result of the cleanup operation 320 may be a shorter and cleaner transaction sequence log 330, which contains more meaningful transaction sequences. For example, transaction sequence “ACACBDE” may be cleaned up to be “ACBDE”, as the two duplicated set of actions “ACAC” may be reduced to one set of actions “AC”. Likewise, transaction sequence “ACBACBDE” may be cleaned up to be “ACBDE” as well, as the “ACBAC” action set may be equivalent to the action set “AC”. Afterward, the preprocessing module 130 may transmit the cleaned transaction sequence log 330, which contains a set of cleaned-up transaction sequences, to the training module 140.

Referring back to FIG. 2, in some embodiments, the training module 140 may generate a normal transaction library 171 and an abnormal transaction library 173 based on the transaction sequences 221 received from the preprocessing module 130. Specifically, the “normal transaction library” and the “abnormal transaction library” may be a part of the “immunity system”. The normal transaction library 171 may be deemed an antibody set, as any elements (e.g., transaction sequences) contained therein can be deemed normal and safe. In addition, any elements that can pass examination and evaluation against the antibody set may also be deemed non-threatening and part of the antibody set. In comparison, the abnormal transaction library 173 may be deemed an allogeneic (or “non-selves”) set, as any elements contained therein may be deemed abnormal or unsafe. Further, any elements that are rejected as being suspicious after compared with the allogeneic set may also be included into the non-selves set. Thus, the normal transaction library 171 may also be referred to as the “antibody set”, and the abnormal transaction library 173 may be referred to as the “non-selves” library.

In some embodiments, during the training operation, the behavior evaluation system may first process a first set of “normal” historical behavior data 201. The preprocessing module 130 may then transmit (220) a set of normal transaction sequences 221 extracted from the normal behavior data 201 to the training module 140, and the training module 140 may store (230) these normal transaction sequences 221 into the normal transaction library 171. Afterward, the behavior evaluation system may process a second set of “abnormal” historical behavior data 201. The preprocessing module 130 may then extract from the normal behavior data 201 a set of abnormal transaction sequences 221, and transmit (220) the abnormal transaction sequences 221 to the training module 140. The training module 140 may then store (230) these abnormal transaction sequences 221 into the abnormal transaction library 173.

In some embodiments, the behavior evaluation system may maintain an immunity system for evaluate user behavior in electronic transactions. Specifically, the “immunity system” may also include a set of evolution procedures to make sure that the data contained in these libraries may evolve throughout time. In other words, as time goes by, a single user's behavior in a similar electronic transaction may change (evolve). In this case, the transaction sequences that are associated with the single user may also evolve throughout time. Thus, the immunity system may utilize these evolution procedures to adjust the transaction sequences in the normal transaction library 171 and the abnormal transaction library 173.

FIG. 3-B illustrates evolving transaction sequences that are associated with a single user performing a specific electronic transaction, according to certain embodiments of the present disclosure. In FIG. 3-B's example, assuming all involved transaction sequences are normal transaction sequences, there are five logs 351, 353, 355, 357, and 359 showing the evolving changes of a single transaction sequence log throughout time. In the very beginning, the specific electronic transaction conducted by the user may include actions “ABDE”, which is stored in the log 351. After a period of time, the user may change its actions to “ACBDE” when performing the same specific electronic transaction. And such a change may be appended to log 351, the result of which being shown in log 353. Similarly, the user's subsequent change-of-behavior in the same specific electronic transaction may lead to logs 355, 357, and 359. Please note that any subsequent log contains all transaction sequences from the previous log, and the new transaction sequences are appended to the newer logs in comparison to the older logs.

In some embodiments, the training module 140 may perform an evolution process to adjust the “age” of the transaction sequences in the transaction sequence library. Specifically, each transaction sequence in the transaction log may be associated with an “age” value representing how “old” this transaction sequence is in comparison to the other transaction sequences that are associated with the same electronic transaction. For example, log 359 may have an “age” column showing the different age values related to the transaction sequences contained in the log 359.

In some embodiments, the training module 140 may adjust the age values of the existing/historical transaction sequences in the log by calculating an affinity score between a new transaction sequence and the historical transaction sequences. For example, the un-shadowed fields in the log 359 may contain existing historical transaction sequences; and the shadowed one (i.e., the last field in the log 359 that contains “ACBDE”) may contain the new transaction sequence appended to the log 350. The “affinity score”, which may be a percentage value, may then be calculated based on a difference (or a distance) between two transaction sequences.

In some embodiments, the “distance” may be a Hausdorff Distance or a Euclidean Distance. For example, the calculated distance between transaction sequences “ABDE” and “ACBDE” may be 1, and the calculated distance between transaction sequences “ADBE” and “ACBDE” may be 3. The training module 140 may then generate the affinity score by comparing the distance with the length of the new transaction sequence, and subtracting the comparison outcome from 1. In other words, the affinity score between transaction sequences “ABDE” and “ACBDE” may be 1⅕=80%, while the affinity score between transaction sequences “ADBE” and “ACBDE” may be 1−⅗=40%.

In some embodiments, when the affinity score between the new transaction sequence and the historical transaction sequence is greater than a predetermined “affinity threshold”, the training module 140 may increase the age of the historical transaction sequence by the distance between the two transaction sequences. In log 359's example, assuming the affinity threshold is set to be 70%, since the affinity score between transaction sequences “ABDE” and “ACBDE” is 80% (which is above the affinity threshold), the age of the historical transaction “ABDE” is not changed. In comparison, the affinity score between transaction sequences “ADBE” and “ACBDE” is 40% (which is below the affinity threshold). Thus, the age of the historical transaction “ADBE” is increased by the distance of 3 (from “3” in log 357 to “6” in log 359).

In some embodiments, any transaction sequences in the library having associated age values that are larger than certain “age threshold” may be deemed “old” and ignored/deleted during subsequent process. Such an approach may ensure that the immunity system will evolve throughout time and remain up-to-date with the more-recent user behaviors.

Referring back to FIG. 2, in some embodiments, after the training session is completed, the behavior evaluation system may be used to evaluate current behavior data 203 received (250) from the behavior evaluation client. The current behavior data 203 may be generated by user actions during a more recent electronic transaction. The behavior evaluation module 150 may theen extract a “current transaction sequence” 261 from the current behavior data 203, and then perform “mutation process” based on the current transaction sequence (or “newly generated transaction sequence”) 261.

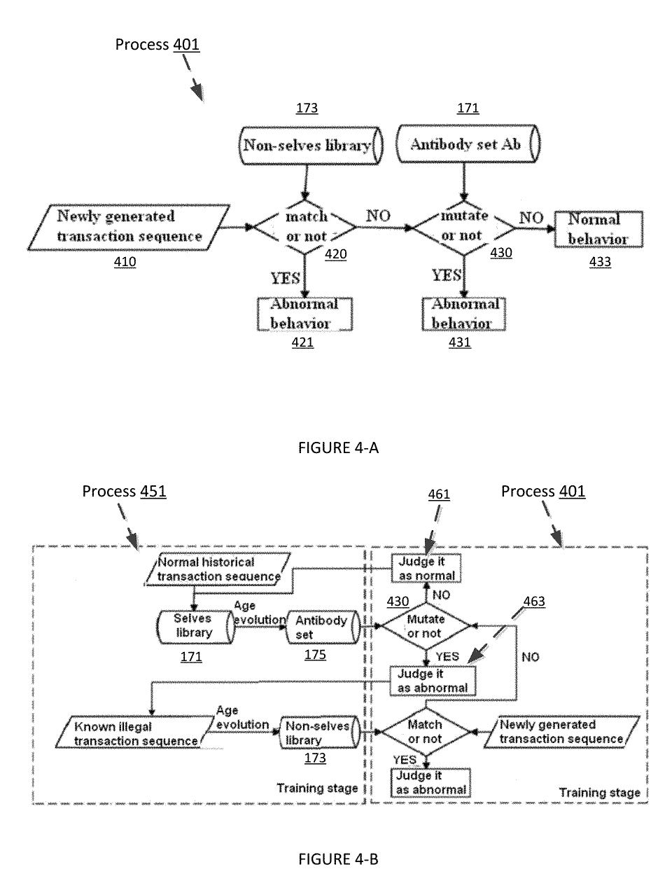

FIG. 4-A illustrates a process 401 to perform a mutation process, according to certain embodiments of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

In some embodiments, a behavior evaluation module (similar to the behavior evaluation module 150 of FIG. 1, not shown in FIG. 4-A) may evaluate the newly generated transaction sequence 410, and perform a matching comparison 420 based on the transaction sequence 410 and the historical abnormal transaction sequences stored in the non-selves library 173 (i.e., the abnormal transaction library 173 of FIG. 1).

In the matching comparison 420, the behavior evaluation module may calculate a distance or an affinity score between the newly generated transaction sequence 410 and each one of the historical abnormal transaction sequences extracted from the non-selves library 173 and corresponding to the same user. If with respect to a specific historical abnormal transaction sequence, the distance is 0 or below a certain distance threshold (e.g., lower-than-threshold), or if the affinity score is above a certain affinity threshold (e.g. larger-than-threshold), then the behavior evaluation module may deem a match successful (e.g., match=YES), and generate an abnormal behavior result 421 associated with the newly generated transaction sequence. In this case, the behavior evaluation module may return the abnormal behavior result 421 back to the behavior evaluation client as a response to the current behavior data. The abnormal behavior result 421 may alarm the administrator or authority the abnormality in user's behavior, and take additional actions such as further examination or user notification.

In some embodiments, if the matching comparison 420 determines that a matching is not successful (e.g., match=NO), process 401 may proceed to operation 430 to perform a mutation comparison. In mutation comparison 430, the behavior evaluation module may evaluate the newly generated transaction sequence 410 with the historical normal transaction sequences extracted from the antibody set 171 and corresponding to the same user. Specifically, the behavior evaluation module may calculate a distance or an affinity score between the newly generated transaction sequence 410 and each one of the historical normal transaction sequences. If a larger-than-threshold distance or a lower-than-threshold affinity score is determined, the behavior evaluation module may deem the mutation comparison's outcome “positive”, and generate an abnormal behavior even 431 for the behavior evaluation client. Otherwise, the behavior evaluation module may deem the mutation comparison's outcome “negative”, and generate a normal behavior result 433 for the behavior evaluation client.

Referring back to FIG. 2, in some embodiments, in addition to the abnormal transaction sequences extracted from known the historical behavior data 201 during the training operation, the behavior evaluation system may also use the normal/abnormal transaction sequences identified during the process 401 to perform an immunity renewal process. Specifically, in the immunity renewal process, the immunity renewal module 160 may, either directly or via the training module 140, update (241) the normal transaction library 171 and/or update (243) the abnormal transaction library 173 using the normal/abnormal transaction sequences 261 received from the behavior evaluation module 150.

In some embodiments, the immunity renewal module 160 may invoke (270) the training module 140, and transmit the current transaction sequences 261 as known normal or know abnormal transaction sequences. The training module 140 may treat the received transaction sequences as training data, and perform the training operation as described above. Alternatively, the immunity renewal module 160 may further evaluate the current transaction sequences 261, and determine that some of the abnormal transaction sequences may actually be new user behavior. In this case, the immunity renewal module 160 may treat these abnormal transaction sequences as “normal”, and transmit to the training module 140 as normal transaction sequences for training. Thus, through this process, the behavior evaluation system may be able to update its immunity system, in order to detect the similar abnormal behavior in subsequence electronic transactions and be immune from this abnormal behavior.

In some embodiments, based on the current normal/abnormal transaction sequences 261, the immunity renewal module 160 may further perform a mutation operation on the historical normal/abnormal transaction sequences stored the libraries 171 and 173.

FIG. 4-B illustrates a process 451 to perform a mutation operation, according to certain embodiments of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

Please note that the right half of the FIG. 4-B include a process that is similar to the process 401 of FIG. 4-A. In FIG. 4-B, the “Judge it as normal” box 461 is similar to the “Normal behavior” box 433 of FIG. 4-A, and the “Judge it as abnormal” box 463 of FIG. 4-B is similar to the “Abnormal behavior” box 431 of FIG. 4-A. In other words, when the behavior evaluation module 150 performs the mutation evaluation 430, the outcomes (normal/abnormal transaction sequences) may be used to “age” the historical transaction sequences in the libraries.

In some embodiments, the immunity renewal module 160 may treat the current normal transaction sequence as “normal historical transaction sequences”, and store it into normal transaction library 171 (e.g., “selves library” 171 of FIG. 4-B). Likewise, the immunity renewal module 160 may store the current abnormal transaction sequence as “known illegal transaction sequences” into abnormal transaction library 173 (e.g., “non-selves library” 173 of FIG. 4-B). Further, the behavior evaluation module 150 may utilize the current normal transaction sequence to perform a mutation operation as described above, and treat the resulting newer normal transaction sequences as the “antibody set” 175. The antibody set 175 may then be used as the antibody set 171 of FIG. 4-A. Likewise, the immunity renewal module 160 may also use the current abnormal transaction sequence to perform a mutation operation on the non-selves library 173 and age the abnormal transaction sequences contained therein.

In some embodiments, after the mutation operation, the behavior evaluation system may treat those normal and abnormal transaction sequences in the selves library 171 and the non-selves library 173 that have an age value being higher than certain age threshold as “aged”. Afterward, the behavior evaluation system may ignore, archive, remove, or even delete the aged normal/abnormal transaction sequences from the selves library 171 and the non-selves library 173, thereby guaranteeing that the libraries can reflect recent behavior habits of the user.

Thus, the immunity renewal module 160 may be able to update the normal transaction library and the abnormal transaction library based on newer and current transaction sequences. Further, the immunity system provided by the behavior evaluation system can ensure that subsequent abnormal situations can be quickly and accurately identified immediately after the first detection of the abnormal user behavior. The immunity system can also evolve through the mutation process, thereby ensure that aged historical transaction sequences may be ignored and not affect the evaluation of the current user behavior.

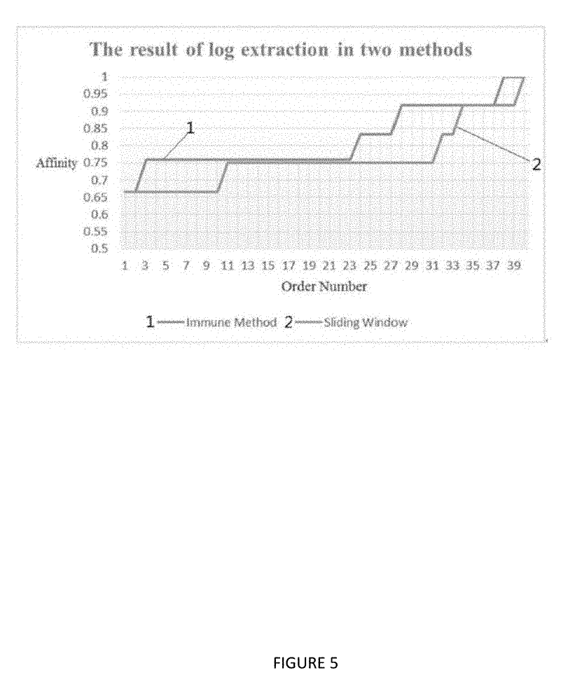

FIG. 5 illustrated a chart showing the improvement of the immunity method provided by the immunity system, according to certain embodiments of the present disclosure. In some embodiments, to know the more recent user behaviors and habits, one approach is to implement a “sliding-window” method of aging the historical transaction sequences in libraries, in which the historical transaction sequences having creation timestamps that are outside of a sliding-window-of-time may be aged and discarded. In comparison, the immunity method described above not only considers the creation time of the historical transaction sequences, but also considers the similarity score or distance between the current and the historical transaction sequences. Thus, in the immunity method, a younger-age transaction sequence in the libraries may be created a longer time ago, while an older-age transaction sequence may be created more recently.

FIG. 5 shows the comparison result of using immunity method and the sliding-window method to perform mutation operation. Based on a common current transaction sequence (e.g., ABDEG) and an affinity threshold of 0.8, after analyzing the sliding windows method and the immune method each extracting 40 historical transaction sequences, the outcome is shown in FIG. 5, in which the immunity method is providing a higher affinity score than that of the sliding-window method.

Table 1 below shows the results of quantitative analysis of the two methods. Specifically, the immunity method may provide an average affinity score of 0.81, which is higher than the affinity threshold of 0.8. In comparison, the sliding-window method may generate an average affinity score of 0.76, which is lower than the affinity threshold of 0.8. In other words, the immunity method may not update the ages of certain historical transaction sequences, while the sliding-window method may increase the ages of these historical transaction sequences. As a result, there are a higher percentage of “younger” historical transaction sequences in immunity method case than in sliding-window method case (e.g., 42.5% vs. 20%). Thus, the libraries adopting the immune method may better reflect the recent behaviors and habits of the user and can be used for detecting whether the newly generated transaction sequences are in compliance with the recent user behaviors and habits.

| | | Percentage of | | |
|---|---|---|---|---|
| | | antibodies with | | Number of |
| | | affinity not | Number of | antibodies with |
| | Average | smaller than | antibodies with | affinity lower |
| | Affinity | 0.8 | affinity equal to 1 | than 0.7 |
| Sliding | 0.76 | 20% | 1 | 10 |
| windows | | | | |
| Immunity | 0.81 | 42.5% | 3 | 2 |
| method | | | | |

Thus, systems and methods for performing behavior evaluation based on an immunity system have been disclosed. The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term non-transitory computer readable storage medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method configured for performing behavior evaluation based on an immunity system, the method comprising:
receiving, by a behavior evaluation system operating based on a physical hardware system, historical behavior data containing user activities performed in an electronic transaction;
extracting, by the behavior evaluation system, normal transaction sequences and abnormal transaction sequences from the historical behavior data;
storing, by the behavior evaluation system, the normal transaction sequences into a normal transaction library and the abnormal transaction sequences into an abnormal transaction library;
in response to receiving a current behavior data, extracting, by the behavior evaluation system, a current transaction sequence from the current behavior data; and
in response to a successful matching comparison of the current transaction sequence with an abnormal transaction sequence in the abnormal transaction library, transmitting, by the behavior evaluation system, a first abnormal evaluation result as a response to the receiving of the current behavior data.

2. The method as recited in claim 1, further comprising:
in response to a positive mutation comparison of the current transaction sequence with a normal transaction sequence in the normal transaction library, transmitting, by the behavior evaluation system, a second abnormal evaluation result as a response to the receiving of the current behavior data.

3. The method as recited in claim 2, further comprising:
storing the current transaction sequence in the abnormal transaction library.

4. The method as recited in claim 1, further comprising:
in response to a negative mutation comparison of the current transaction sequence with a normal transaction sequence in the normal transaction library, transmitting, by the behavior evaluation system, a normal evaluation result as a response to the receiving of the current behavior data.

5. The method as recited in claim 4, further comprising:
storing the current transaction sequence in the normal transaction library.

6. The method as recited in claim 1, further comprising:
calculating an affinity score between the current transaction sequence and a specific normal transaction sequence in the normal transaction library; and
in response to a determination that the affinity score is below a predetermined affinity threshold, adjusting a corresponding age value associated with the specific normal transaction sequence in the normal transaction library.

7. The method as recited in claim 1, further comprising:
calculating an affinity score between the current transaction sequence and a specific abnormal transaction sequence in the abnormal transaction library; and
in response to a determination that the affinity score is below a predetermined affinity threshold, adjusting a corresponding age value associated with the specific abnormal transaction sequence in the abnormal transaction library.

8. The method as recited in claim 7, further comprising:
selecting a specific abnormal transaction sequence in the abnormal transaction library for the matching comparison; and
in response to a determination that the corresponding age value of the specific abnormal transaction sequence is above a predetermined age threshold, removing the specific abnormal transaction sequence from the matching comparison.

9. The method as recited in claim 7, further comprising:
deleting the specific abnormal transaction sequence from the abnormal transaction library.

10. The method as recited in claim 7, wherein the calculating of the affinity score comprises:
calculating a distance between the current transaction sequence and a specific abnormal transaction sequence; and
generating the affinity score based on the distance and the length of the current transaction sequence.

11. A non-transitory computer-readable storage medium, containing a set of instructions which, when executed by a processor, cause the processor to perform a method for performing behavior evaluation based on an immunity system, the method comprising:
generating, by a behavior evaluation system operating based on a physical hardware system, a normal transaction library and an abnormal transaction library based on historical behavior data containing user activities performed in an electronic transaction, wherein the normal transaction library contains normal transaction sequences and the abnormal transaction library contains abnormal transaction sequences;
receiving, by the behavior evaluation system, a current transaction sequence containing current user activities performed in the electronic transaction; and
in response to a successful matching comparison of the current transaction sequence with an abnormal transaction sequence in the abnormal transaction library, transmitting, by the behavior evaluation system, a first abnormal evaluation result as a response to the receiving of the current transaction sequence.

12. The non-transitory computer-readable storage medium as recited in claim 11, wherein the method further comprises:
in response to a positive mutation comparison of the current transaction sequence with a normal transaction sequence in the normal transaction library, transmitting, by the behavior evaluation system, a second abnormal evaluation result as a response to the receiving of the current transaction sequence; and
storing the current transaction sequence in the abnormal transaction library.

13. The non-transitory computer-readable storage medium as recited in claim 11, wherein the method further comprises:
in response to a negative mutation comparison of the current transaction sequence with a normal transaction sequence in the normal transaction library, transmitting, by the behavior evaluation system, a normal evaluation result as a response to the receiving of the current transaction sequence; and
storing the current transaction sequence in the normal transaction library.

14. The non-transitory computer-readable storage medium as recited in claim 13, wherein the method further comprises:
calculating an affinity score between the current transaction sequence and a specific normal transaction sequence in the normal transaction library; and
in response to a determination that the affinity score is below a predetermined affinity threshold, adjusting a corresponding age value associated with the specific normal transaction sequence in the normal transaction library.

15. The non-transitory computer-readable storage medium as recited in claim 14, wherein the method further comprises:
selecting a specific abnormal transaction sequence in the abnormal transaction library for the matching comparison; and
in response to a determination that the corresponding age value of the specific abnormal transaction sequence is above a predetermined age threshold, removing the specific abnormal transaction sequence from the matching comparison.

16. The non-transitory computer-readable storage medium as recited in claim 14, wherein the method further comprises:
selecting a specific normal transaction sequence in the normal transaction library for the mutation comparison; and
in response to a determination that the corresponding age value of the specific normal transaction sequence is above a predetermined age threshold, removing the specific normal transaction sequence from the mutation comparison.

17. A system configured for performing behavior evaluation based on an immunity system, the system comprises:
a preprocessing module for receiving historical behavior data containing user activities performed in an electronic transaction and extracting normal transaction sequences and abnormal transaction sequences from the historical behavior data;
a training module for storing the normal transaction sequences into a normal transaction library and the abnormal transaction sequences into an abnormal transaction library; and
a behavior evaluation module coupled with the training module, the normal transaction library, and the abnormal transaction library, wherein the behavior evaluation module is configured to
extract a current transaction sequence from a current behavior data, and
in response to a successful matching comparison of the current transaction sequence with an abnormal transaction sequence in the abnormal transaction library, transmit a first abnormal evaluation result as a response to the current behavior data.

18. The system as recited in claim 17, wherein the behavior evaluation module is further configured to:
in response to a positive mutation comparison of the current transaction sequence with a normal transaction sequence in the normal transaction library, transmit a second abnormal evaluation result as a response to the current behavior data.

19. The system as recited in claim 17, wherein the behavior evaluation module is further configured to:
in response to a negative mutation comparison of the current transaction sequence with a normal transaction sequence in the normal transaction library, transmit a normal evaluation result as a response to the receiving of the current behavior data.

20. The system as recited in claim 17, further comprising:
an immunity renewal module coupled with the behavior evaluation module, wherein the immunity renewal module
calculates an affinity score between the current transaction sequence and a specific abnormal transaction sequence in the abnormal transaction library; and
in response to a determination that the affinity score is below a predetermined affinity threshold, adjusts a corresponding age value associated with the specific abnormal transaction sequence in the abnormal transaction library.
